(19) United States
(12) Patent Application Publication
(10) Pub. No.: US 2008/0113677 A1
(43) Pub. Date: May 15, 2008

(54) Mobile to mobile service invocation framework using text messsaging

(76) Inventor: Rajeev Kumar Madnawat, Milpitas, CA (US)

Correspondence Address: Rajeev Madnawat, P.O. BOX 360011, MILPITAS, CA, 95036, US

(21) Appl. No.: 11/558,903

(22) Filed: Nov. 11, 2006

(51) Int. Cl. H04Q 7/20

(52) U.S. Cl. 455/466

(57) ABSTRACT

A system, process and methods for providing a mobile to mobile service invocation framework in which a mobile device can invoke a service or request a data from another mobile or non-mobile device. The request from a mobile device is sent as a text message to another mobile device's phone number or as an email to another mobile device or non-mobile device. The request contains, among other things, a command and required data to enable the framework running on the destination device to execute the request and return the result as a text message back to the caller device. The framework also breaks the text message into pieces of max allowed size before sending, and, the pieces are rejoined by the framework at receiving end before executing a service.

### BACKGROUND OF INVENTION

1. Field of the Invention

This invention relates to a remote service invocation framework for mobile devices, in which the text messaging is used to invoke remote services and transferring service related data.

2. Background and Description of the Related Art

Cell phones have gained a wider popularity in the masses. In fact, the cell phones have become an indispensable part of day-to-day life of a substantial percentage of the global population. The popularity of the cell phone is evident from the fact that newer and newer uses of these devices are being discovered. Efforts are being made to use the cell phones for making payments to buying public transit tickets etc.

Text messaging is one of the most popular uses of cell phones. Text messaging is easy to use and provides a fail proof way to sending and receiving messages. Text messaging is used for sending and receiving simple text messages. It is possible to use text messaging for more powerful and useful applications. This invention is an effort to leverage the text messaging function of cell phones.

A similar concept to client-server computer architecture in which a mobile device can act as a server of the data or service is non-existent. Mobile devices have become powerful computing devices; most mobile phones come preinstalled with a Java Virtual Machine or equivalent mobile runtime environments, which are used to run various mobile applications. However, there is no framework available to leverage this computing power to enable mobile-to-mobile client-server computing.

The intent of this invention is to define a framework to enable mobile-to-mobile or mobile to a non-mobile computing device to communicate at service level.

Using this proposed framework, a mobile device or a non-mobile device can publish their services and provide service to the mobile clients.

Developing applications/services to enable mobile-to-mobile service collaboration using text messaging is very difficult because there no common service framework exists for developing collaborative services leveraging text messaging in mobile devices.

The development in technology has enabled a wider use of internet on mobile devices. This internet connectivity along with the processing capabilities can be used to use the mobile devices as client computers to access remote services running on server computers. However, internet connectivity is expensive and not fully adapted by the masses. On the other hand, text messaging is widely popular globally among the mobile device users.

One use of this framework is to let the mobile and non-mobile devices to act as servers to provide services. A mobile device can send a text message with a service command and required data to another mobile or non-mobile device to request certain data. For example, a company representative travels to another destination for a meeting with a client. After the meeting, he enters notes in his/her mobile device. However, he does not need to call all of the interested parties to let them know of the current development; these interested parties may send a request embedded in a text message to the mobile device of said company representative to retrieve pertinent data.

Similarly, a poll service integrated in the proposed framework could be used to conduct mobile-to-mobile polls. For example, a person calls poll services in the cell phones of his friends to ask them if they want to go to a particular movie. The receiving phones displays a dynamically-built screen using the metadata of the service definition which allows the user to select “Yes” or “No”. The sender phone collects all the responses and displays a screen showing individual responses.

The proposed framework can also be used for developing personal collaboration applications such as querying the calendar of another person's mobile device, creating appointments, task etc.

All the uses given in above examples can be developed without the use of this proposed framework. However, every developer will have to rewrite the service interaction layer, which is to be provided by the proposed framework. Therefore, developing applications as per the specifications of this framework will lower the development cost and time and will be easier to maintain and deploy.

### BRIEF DESCRIPTION OF THE DRAWINGS

A better understanding of the present invention can be obtained from the following detailed description in conjunction with the following drawings, in which:

FIG. 1 illustrates current practice of conducting a mobile-to-mobile data exchange.

FIG. 2 illustrates the concept of mobile-to-mobile service invocation framework.

FIG. 3 illustrates the flow of control for querying another mobile device for available services, retrieving a list of service along with the metadata and dynamically drawing a screen for the user to invoke the service.

FIG. 4a illustrates a sample metadata format.

FIG. 4b illustrates a sample screen dynamically drawn by the framework using service metadata illustrated in FIG. 4a.

FIG. 5 illustrates the process of invoking a service at another device.

FIGS. 6 and 7 illustrates a flow of breaking the text message into pieces and rejoining the pieces again into one text message respectively.

These figures are provided in order to provide a thorough understanding of the present invention. The figures should not be construed as limiting the breadth of the invention in any manner.

### DETAILED DESCRIPTION

### Current System of Exchanging Data

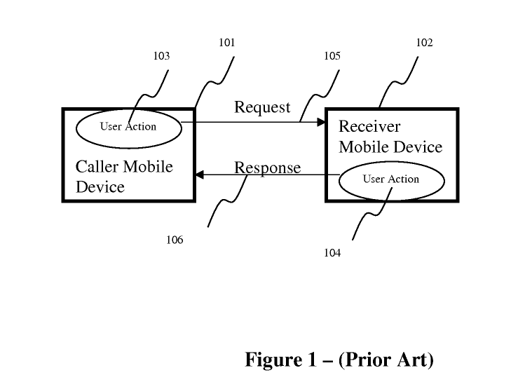

FIG. 1 illustrates how data is exchanged between two mobile devices. Mobile device 101 with the help of a user action 103 sends a request 105 as a text message to another device 102. The message is interpreted by the user 104 and a response 106 is sent back to the mobile device 101.

Mobile service providers have enabled remote services in which a mobile device may send a text message to a service provider and the service provider supplies the data. This feature is widely used for receiving stock quotes and similar information. However, this is a mobile to a fixed server scheme. This scheme does not enable a mobile device to retrieve data stored in another mobile device.

### Mobile-to-Mobile Service Invocation

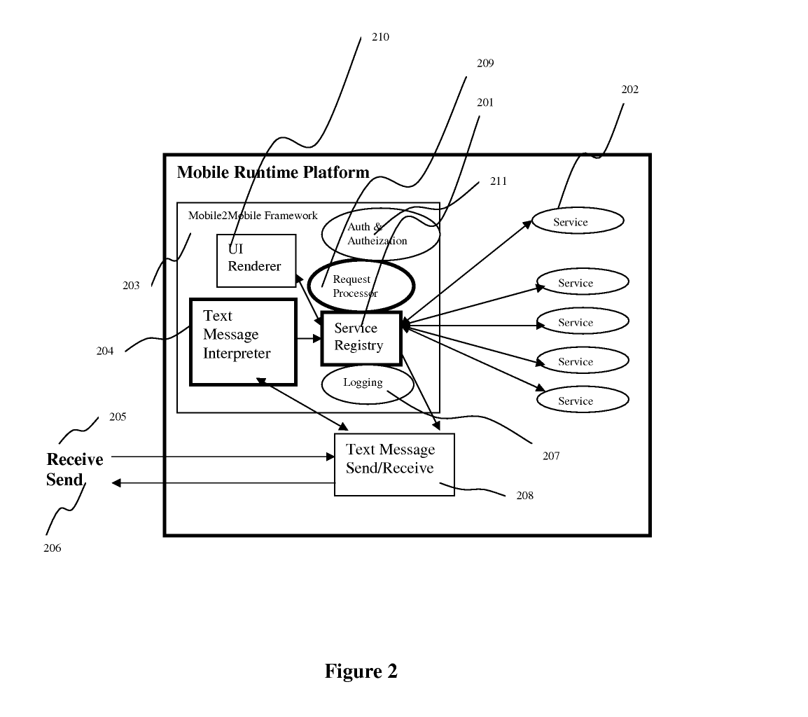

FIG. 2 illustrates the proposed mobile-to-mobile service invocation framework 203 that uses text messaging to provide remote invocation of services running on mobile devices. It is comprised of a text message interpreter 204 which intercepts through a mobile text message send/receive service 208, all incoming text messages 205 to see if they are service invocation requests or simple text messages. It also contains a service registry 201 in which the running services 202 register themselves, a request processor 209 that reads the incoming service request, looks up the service registry 201 for a running service 202 which can execute the request and invoke the service. This request processor 209 also receives either error messages or results of execution and send the message back to text message interpreter 204 for breaking up the message, if necessary, before the message is sent back to the caller 206 through the text message send/receive service 208.

The mobile-to-mobile framework also contains a logging component 207 which keeps track of incoming and outgoing requests and logs necessary information as configured by the user of the framework. User may turn the logging on or off.

The mobile-to-mobile framework also contains a universal UI Renderer 210 which can read the service metadata and render an input or output form dynamically.

The mobile-to-mobile framework, along with the implemented services, runs in the mobile runtime environment.

The services 202 requesting registration with the service registry 201 need to provide some information about themselves in a predefined format. This information may contain the names of implemented commands, input/output values along with data types, and a brief description of the command etc.

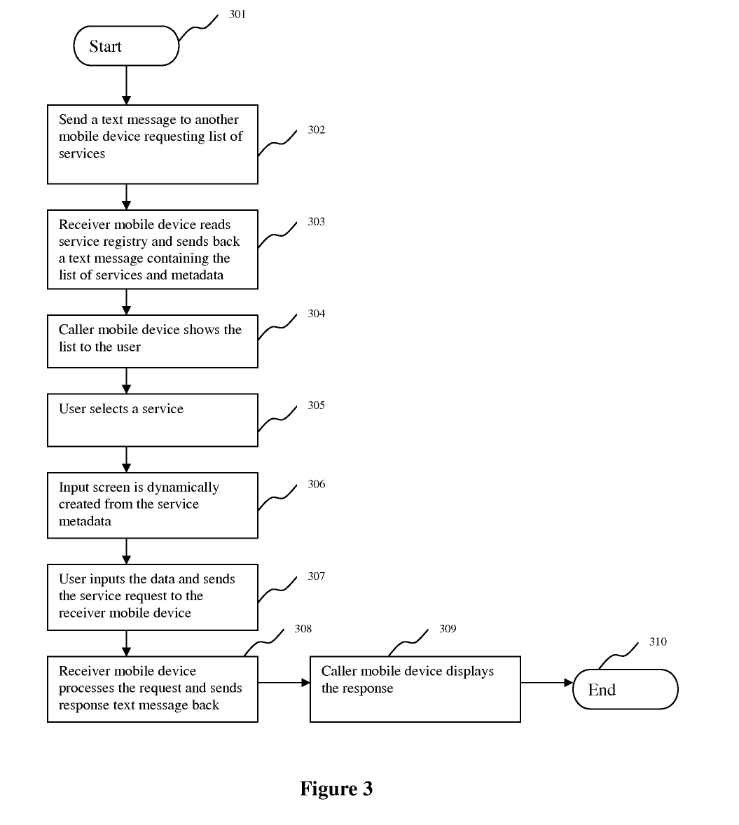

FIG. 3 illustrates a flow of control when a caller device requests a list of services from a receiver device. A caller device starts 301 with sending a text message to receiver device requesting the list of services 302. Receiver mobile device reads service registry 201 and sends back a text message containing the list of services and metadata 303. Caller mobile device shows the list to the user 304. User selects a service 305. Input screen to enable calling a selected service is dynamically created from the service metadata by the mobile-to-mobile framework 306. User inputs the data in the input screen and sends the service request to receiver mobile device 307. Receiver mobile device processes the request and sends response text message back 308. Caller mobile device displays the response to the user 309.

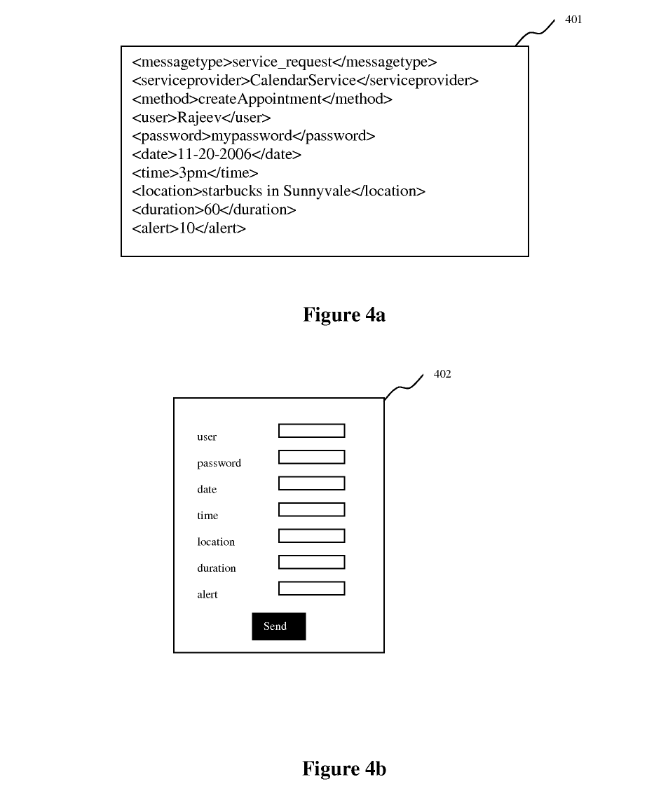

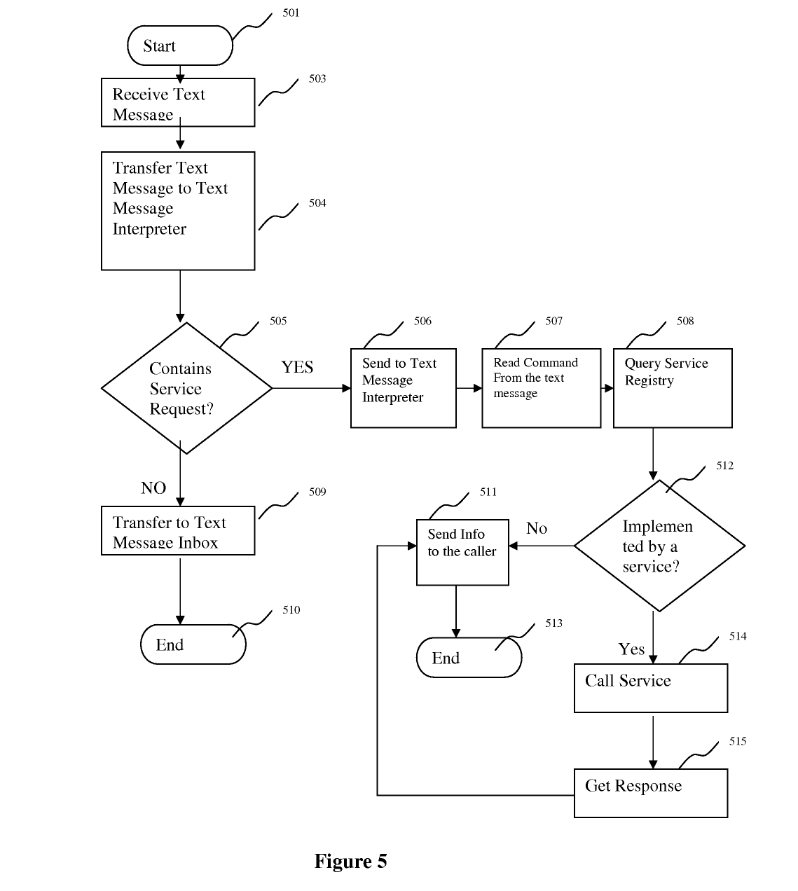

FIG. 4a and FIG. 4b illustrates a sample service metadata 401 and a UI rendering 402 of this sample metadata. UI Renderer 210 is capable of reading the metadata arranged in a predefined form (such as an XML data segment) and draw simple input and output screens. It should be noted that a person skilled in the art would realize that there are many ways to implement this UI Renderer 210. One of the simple ways is to use internet browser control and cascaded style sheets to draw screen components from xml documents.

In this document, XML (Extensible Markup Language) is used to represent text messaging data. However, it should be noted that a person skilled in the art would realize that other mediums (such as name value pair method etc) of representing data may be used instead.

### Invoking the Service

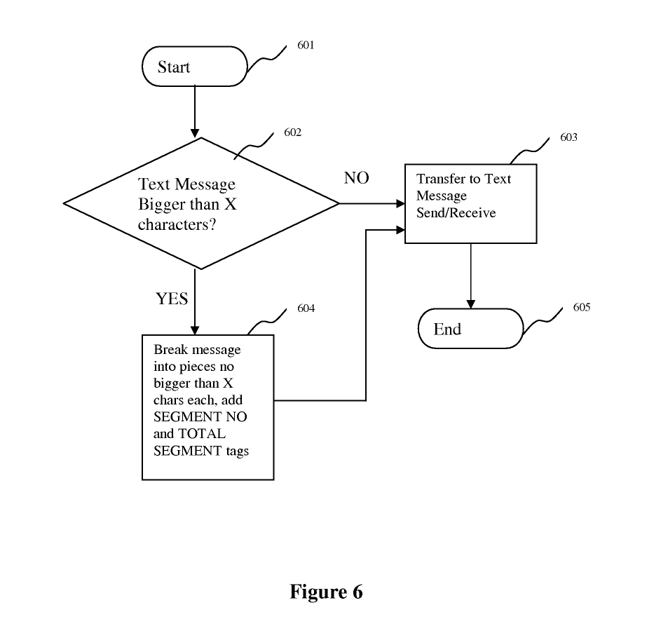

FIG. 5 illustrates a flow of control of receiving a text message, executing the command and sending back the message. The process starts 501 when a text message is received 503. The text message is intercepted by the message interpreter 204 to check if this is a service request 504. If the message contains a service request 505, it is sent to the request processor 209 in steps 506 and 507. One way to find if this is a service request is to check if the text message 401 contains a tag named “servicetype” and the value is “service_request”. However, a person skilled in the art will realize that this functionality can be implemented using other tag names, values and processes.

If the text message does not contain a service request, it is simply transferred to mobile device's text message inbox 509 and the process ends 510.

If the message contains a service request, the message is sent to the request processor which reads the command from the text message 507. The request processor queries the service registry 508 to see if the requested command is implemented by any running service 512. If no running service is found to process the command, this information is sent back to the caller 511 and the process ends 513. If the request processor finds a running service to process the command, it calls the service 514, gets the response 515, and sends the response back to the user 511 though message interpreter and mobile device's send/receive text service.

In another embodiment, if the password is required to invoke a service, for security reasons, the sender and receiver may use commonly available PKI (Public Key Infrastructure) methods to encrypt and decrypt the passwords. In PKI, a sender uses his secret private key to encrypt the password and sends along his public key to the receiver. The receiver can use the sender's public key to decrypt the password. For authentication security, a commonly employed trusted authority mechanism may be used. For example—A texts B requesting a transaction. B texts A with the code. A then forwards the message to “C”, a trusted intermediary, encrypted with his C's public code. C then decrypts it, and sends a confirmation to B with the original code.

### Managing the Size of Text Messages

Using the text messaging poses a problem. In most cases, the size of a text message is limited to a particular size in terms of the number of characters. To overcome this issue, the mobile-to-mobile framework provides a transparent service to break the message into smaller pieces and rejoin these pieces to form one single message at the receiving side.

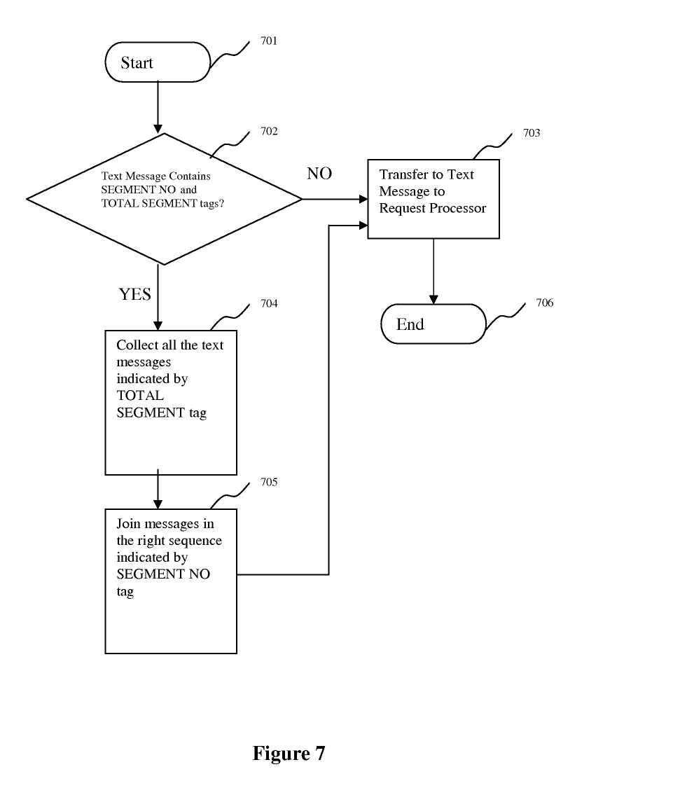

FIG. 6 and FIG. 7 illustrates a flow of control to see if the size of the text message is within a max size defined by the service providers. Basically, before sending the message 601 the framework checks if the size of the text message is bigger than the max size permitted 602. If the text message size is bigger than what is permitted, the framework message interpreter breaks the message into smaller pieces and adds tags to each of the individual broken segments 604 to indicate to the receiver that incoming text messages with this particular tags are individual parts of a bigger message. One way to implement is to add two segments such as SEGMENT_NO and TOTAL_SEGMENTS. It should be noted that a person skilled in the art would realize that this functionality could be implemented using other tag names, values and processes. The messages are then sent to text message send/receive service 603.

Similarly, at the receiver end logic is run in the text interpreter to see if incoming messages contain tags to indicate that the messages are segments of a big message 702. If the answer is no then the message is processed in a normal way as described in FIG. 5. However, if the message contains the tag to indicate that this message is a part of a big message, the message interpreter collects all the message segments (each message segment contains how many total parts are expected). Combines 705 all the segments by given segment number (or similar process) and transfers 703 the reconstructed message to text message request processor of mobile-to-mobile framework for further processing as illustrated in FIG. 5.

### Authentication and Authorization

As illustrated in FIG. 2, the mobile-to-mobile framework also provides authentication and authorization services 211 for verifying the credentials and access permissions of the sender. A user of the mobile device may create one or more users who are allowed to invoke a particular service. The user may also create a global user and password that can access one or more services selected from the service registry.

The Authentication & Authorization service will also allow the user to set rules such as “anyone in my phone book can access the following services” or “anyone listed in group ‘friend’ in my address book is allowed to access the following or all services”.

In one embodiment, the authentication service can be implemented through a lookup of “allowed users” list for the user name contained in the incoming text message, followed by matching the password from the authentication service store with the one contained in the incoming text message. It should be noted that a person skilled in the art would realize that there are many ways to implement this functionality.

What is claimed is:

1. A mobile device to mobile device service invocation framework comprising:
a text message interpreter coupled to a text message send/receive service of said mobile device to check if a text message contains a service request;
a service registry coupled to said text message interpreter to register a mobile service;
a request processor coupled to said service registry to read said service request and to query said service registry and to invoke said mobile service; and
a authentication and authorization service coupled to said request processor.

2. The mobile device to mobile device service invocation framework as in claim 1 further comprising:
a logger coupled to said service registry to log error messages.

3. The mobile device to mobile device service invocation framework as in claim 1 further comprising:
a UI Renderer to dynamically draw a input or output form from metadata of said mobile service.

4. A method of invoking a service running on a first mobile device from a second mobile device comprising:
receiving a text message;
verifying credentials and access permissions;
checking said text message for a service request;
querying a service registry for a service to process said service request;
calling said service to process said service request;
receiving response from said service; and
sending a response text message to the caller mobile device.

5. A method of invoking a service running of a first mobile device from a second mobile device as in claim 4 further comprising:
checking if said text message is a part of a bigger text message; and
combining plurality of said text messages to form said bigger text message.

6. A method of invoking a service running of a first mobile device from a second mobile device as in claim 4 further comprising:
checking if size of said response text message is bigger than maximum allowed;
breaking said response text message into message segments; and
adding information in each of said message segments to indicate segment number and total number of segments.

7. A method of invoking a service running of a first mobile device from a second mobile device as in claim 4 further comprising:
reading metadata of said service;
rendering input user interface from said metadata; and
rendering output user interface from said metadata.
